(19) United States
(12) Patent Application Publication
(10) Pub. No.: US 2025/0391597 A1
(43) Pub. Date: Dec. 25, 2025

(54) INDUCTOR

(71) Applicant: TAI-TECH ADVANCED ELECTRONICS CO., LTD., Taoyuan City (TW)

(72) Inventors: Ming-Yen Hsieh, Taoyuan City (TW); Cheng-Han Yu, Taoyuan City (TW); Chun-Te Tsou, Taoyuan City (TW); Kuan-Yi Lu, Taoyuan City (TW)

(21) Appl. No.: 18/748,118

(22) Filed: Jun. 20, 2024

(51) Int. Cl. H01F 27/00; H01F 1/147; H01F 27/28; H01F 27/29; H01F 27/32

(52) U.S. Cl. CPC H01F 27/006; H01F 1/14766; H01F 27/2847; H01F 27/323; H01F 27/292

(57) ABSTRACT

The inductor includes a first coil, a second coil, and a covering layer. The first coil includes a first body section, a first terminal section, and a second terminal section. The first body section includes end-to-end connected straight and curved segments. The first and second terminal sections are connected to the first body section. Both the first and second terminal sections are arranged along a first straight line. The second coil includes a second body section, a third terminal section, and a fourth terminal section. The second body section includes an inclined segment, straight and curved segments. The inclined segment is connected to end-to-end connected straight and curved segments. The third and fourth terminal sections are connected to the second body section. The third and fourth terminal sections are arranged in a staggered manner and located on separate straight lines, respectively. The covering layer covering the first and second coils.

### BACKGROUND OF THE INVENTION

### (a) Technical Field of the Invention

The present invention generally relates to inductors, and more particularly to an inverse coupled inductor.

### (b) Description of the Prior Art

A coupled inductor refers to two coils connected through electromagnetic induction. When a coil experiences a changing current, it creates an induced magnetic field around it. If the magnetic fields of the two coils interact, the two coils are said to have magnetic coupling. Generally, due to spatial and dimensional constraints, the two coils of a coupled inductor are typically arranged in an overlapping manner. The closer the coils are to each other, the better the coupling effect. However, they should not touch each other, as this would cause a short circuit.

For example, R.O.C. Taiwan Patent No. 1816289 discloses a coupled inductor and its manufacturing method. This inductor includes two pillars aligned in a vertical direction, with a first coil and a second coil respectively wound around one of the two pillars. The lower surface of the winding turns of the first coil and the upper surface of the winding turns of the second coil are separated by a gap, with a magnetic material positioned in the gap. Each of the first coil and the second coil is aligned in a straight line passing through the two pillars.

However, as shown in FIG. 4 of the patent, the terminals of the two stacked coils overlap. For example, when the two coils are vertically stacked, the terminals of the lower coil are covered by the upper coil, resulting in a limited overlapping area. Yet, it is well known that the larger the overlapping area, the better the coupling factor (k value).

### SUMMARY OF THE INVENTION

To increase the overlapping area and thereby improve the coupling factor, the present invention discloses a novel inductor.

The inductor includes a first coil, a second coil, and a covering layer. The first coil includes a first body section, a first terminal section, and a second terminal section. The first body section includes several straight segments and curved segments alternately end-to-end connected together. The first terminal section and the second terminal section are connected to the first body section's two ends, respectively. The first terminal section is straight, while the second terminal section is bent. Both the first terminal section and the second terminal section are arranged along a first straight line. The second coil includes a second body section, a third terminal section, and a fourth terminal section. The second body section includes an inclined segment, several straight segments and curved segments. The inclined segment is connected to alternately end-to-end connected straight and curved segments. The third terminal section and the fourth terminal section are connected to the second body section's two ends. The third terminal section is straight, while the fourth terminal section is bent. The third terminal section and the fourth terminal section are arranged in a staggered manner, with the third terminal section and the fourth terminal section located on a second straight line and a third straight line, respectively. The covering layer is made of alloy powder covering the first coil and the second coil.

Specifically, at least an isolation layer is provided between the first coil and the second coil.

Specifically, a gap is provided between the first coil and the second coil.

Specifically, the first coil and the second coil are placed on a core, and the core is positioned on a core base.

Specifically, the alloy powder is FeSiCr alloy powder.

Specifically, the first coil and the second coil are flat coils.

In general, when the first coil and the second coil overlap in arrangement (the closer the coils are to each other, the better the coupling effect, but they must not touch each other), the space and dimension often leads to relatively lower inductance. The present invention addresses this by having the first body section of the first coil composed of multiple straight segments and curved segments, and the second body section of the second coil composed of an inclined segment, multiple straight segments, and curved segments, forming the third terminal section and the fourth terminal section in a staggered arrangement. This arrangement increases the overlapping area of the third terminal section and the fourth terminal section, thereby enhancing the inductance.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing an inductor according to an embodiment of the present invention.

FIG. 2 is a perspective diagram showing a first coil and a second coil of the inductor of FIG. 1.

FIG. 3 is a perspective break-down diagram of FIG. 2.

FIG. 4 is a perspective diagram showing an isolation layer provided between the first coil and the second coil of FIG. 2.

FIG. 5 is a perspective break-down diagram of FIG. 4.

FIG. 6 is a perspective diagram showing the first coil and the second coil of FIG. 2 placed on a core.

FIG. 7 is a perspective break-down diagram of FIG. 6.

FIG. 8 is a perspective diagram showing the first coil and the second coil of FIG. 4 placed on a core.

FIG. 9 is a perspective break-down diagram of FIG. 8.

FIG. 10 is a schematic diagram showing the first coil and the second coil of FIG. 2 are aligned along a line A while a third terminal section and fourth terminal section are respectively located on separate lines B and C.

FIG. 11 is a perspective diagram showing a conventional inductor.

FIG. 11A is a perspective break-down diagram of FIG. 11.

FIG. 12 depicts the data of the conventional inductor of FIG. 10 and that of the inductor of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

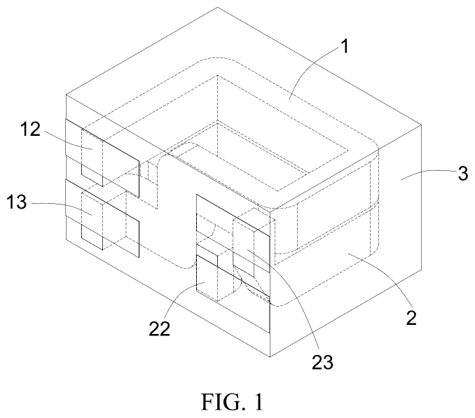

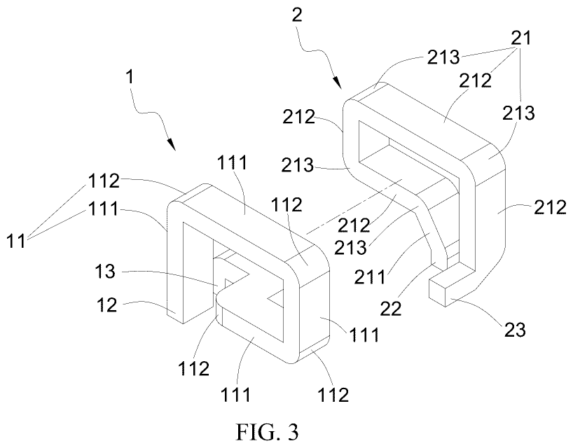

As shown in FIGS. 1 to 3, an inductor according to an embodiment of the present invention includes a first coil 1, a second coil 2, and a covering layer 3.

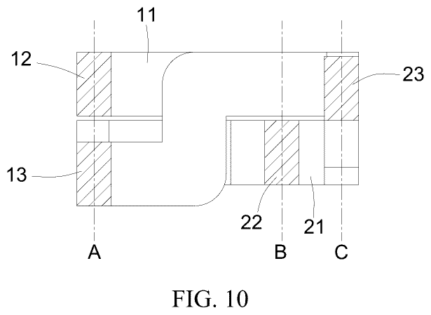

The first coil 1 includes a first body section 11, a first terminal section 12, and a second terminal section 13. The first body section 11 is composed of several straight segments 111 and several curved segments 112 alternately end-to-end connected together. The first terminal section 12 and the second terminal section 13 are connected to the first body section 11's two ends, respectively. The first terminal section 12 is straight, while the second terminal section 13 is bent. Both the first terminal section 12 and the second terminal section 13 are arranged along a first straight line A (as shown in FIG. 10).

The second coil 2 includes a second body section 21, a third terminal section 22, and a fourth terminal section 23. The second body section 21 is composed of an inclined segment 211, several straight segments 212, and several curved segments 213. The inclined segment 211 is connected to alternately end-to-end connected straight and curved segments 212 and 213. The third terminal section 22 and the fourth terminal section 23 are connected to the second body section 21's two ends. The third terminal section 22 is straight, while the fourth terminal section 23 is bent. The third terminal section 22 and the fourth terminal section 23 are arranged in a staggered manner, with the third terminal section 22 and the fourth terminal section 23 located on the second straight line B and the third straight line C, respectively (as shown in FIG. 10, the third terminal section 22 is located on the second straight line B, and the fourth terminal section 23 is located on the third straight line C).

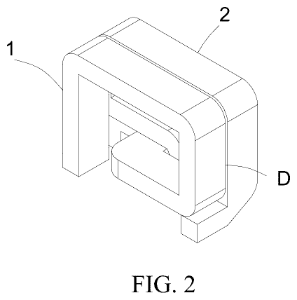

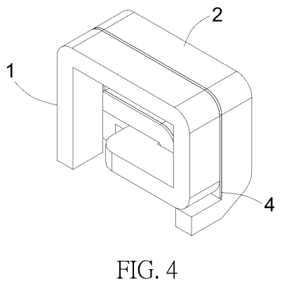

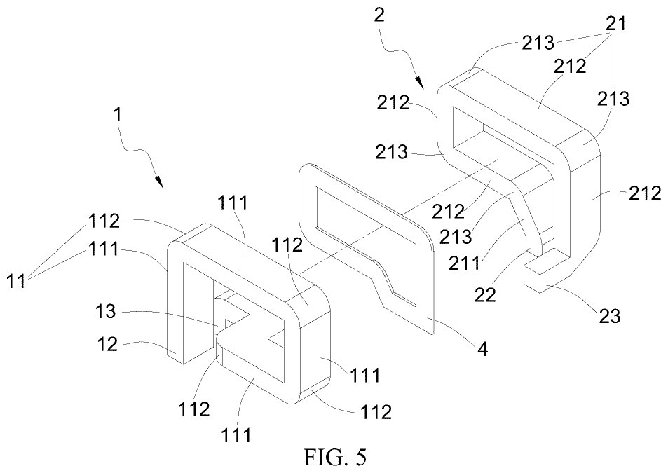

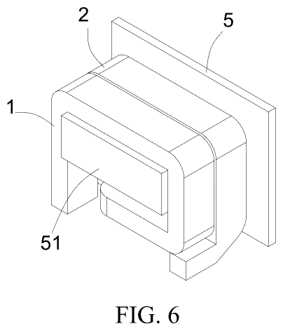

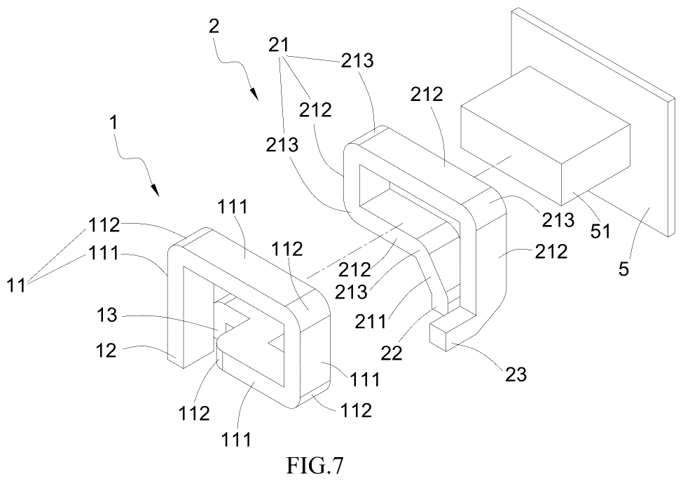

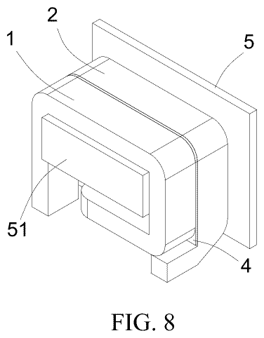

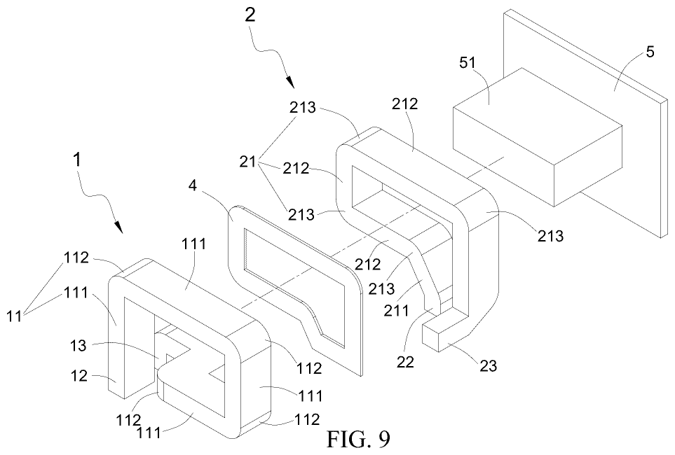

The first coil 1 and the second coil 2 can be flat coils. A gap D may be provided between the first coil 1 and the second coil 2 (as shown in FIG. 2). There may also be at least one isolation layer 4 between the first coil 1 and the second coil 2 (as shown in FIGS. 4 and 5). This isolation layer 4 can be a non-conductive material. This is to prevent a short circuit caused by the first coil 1 and the second coil 2 coming into contact with each other. Therefore, a gap D (or isolation layer 4) can be provided between the first coil 1 and the second coil 2. Additionally, as shown in FIGS. 6 and 7, the first coil 1 and the second coil 2 can be placed on a core 51, which is positioned on a core base 5. As shown in FIGS. 8 and 9, there may be at least one isolation layer 4 between the first coil 1 and the second coil 2, and at the same time, the first coil 1 and the second coil 2 can be placed on a core 51, which is positioned on a core base 5.

The covering layer 3 (as shown in FIG. 1) is made of alloy powder and covers the first coil 1 and the second coil 2. The alloy powder can be FeSiCr alloy powder.

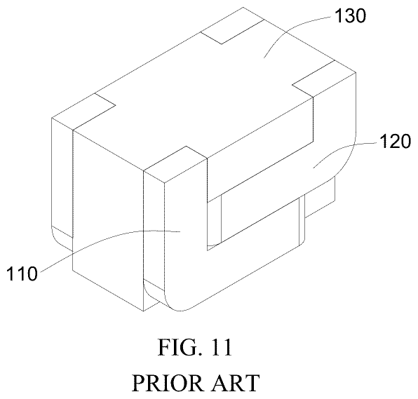

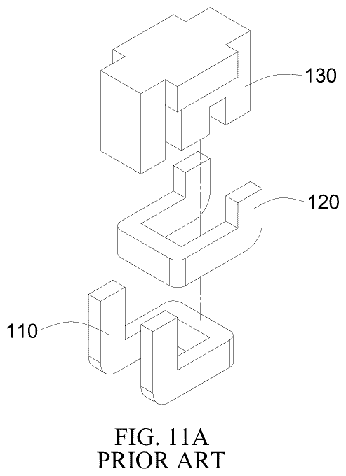

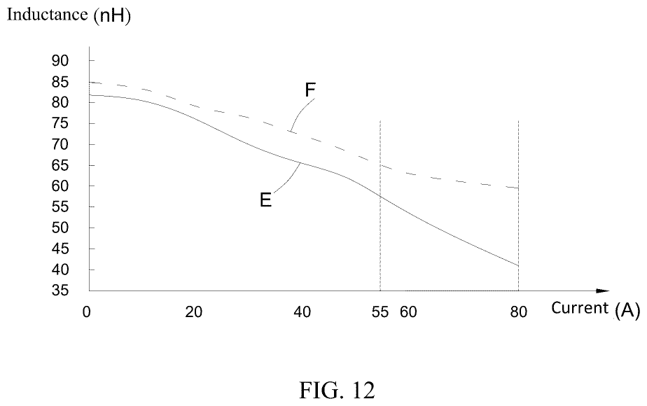

Table 1 and FIG. 12 show the test data for the inductor of the present invention and a conventional inductor as shown in FIGS. 11 and 11A.

As illustrated, the conventional inductor includes a conventional first coil 110, a conventional second coil 120, and a conventional core 130, with the conventional first coil 110 and the conventional second coil 120 being placed on the conventional core 130.

TABLE 1

| | | | Rdc [mQ] | | Isat [A] | | Coefficient of | Dimensions [mm] | | | | |
|---|---|---|---|---|---|---|---|---|---|---|---|---|
| | Li [nH] | | DC Resistance | | Li Drop 30% | | coupling | Length | | Width | | Thickness |
| Brand | Type | 100 KHz, ±20% | typ. | max. | typ. | max. | K | typ. | tol. | typ. | tol. | max. |
| Present | FeSiCr | 85 | 0.29 | 0.3 | 80 | — | 0.50-0.60 | 8.00 | ±0.25 | 5.00 | ±0.25 | 6 |
| Invention | | | | | | | | | | | | |
| Conventional | FeSiCr | 82 | 0.22 | 0.3 | 55 | — | 0.25 | 8.00 | ±0.25 | 5.00 | ±0.25 | 6 |

In Table 1, Li is the input inductance, Rdc is the DC resistance, Isat is the saturation current, Coefficient of coupling is the coupling coefficient, Li drop is the input inductance drop, K is the coupling coefficient.

It can be seen from Table 1 that the inductor of the present invention is superior to the conventional inductor in various aspects.

Also, in FIG. 12, the first curve E represents the conventional inductor, and the second curve F represents the inductor of the present invention. When the Isat of the present invention's inductor reaches 80 A, the inductance value drops by 30% (from 85 nH to approximately 60 nH); when the Isat of the conventional inductor reaches 55 A, the inductance value drops by 30% (from 82 nH to approximately 57 nH). A higher Isat value indicates a stronger current tolerance capability. The criterion for comparison is based on a 30% decrease in inductance value measured after applying current. From the experiment, FIG. 12 indicates that the inductor of the present invention has a characteristic of higher current tolerance.

Therefore, the inductor of the present invention has the following advantages.

First, it has a high coupling factor (k value).

Second, it can be molded with alloy powder, that is, using alloy powder to form the covering layer 3.

Third, there are at least two coils, namely the first coil 1 and the second coil 2.

Fourth, the first coil 1 and the second coil 2 can induce current in opposite directions to generate inductance.

Fifth, the first coil 1 and the second coil 2 are offset to have the characteristic of inverse coupling, which can be used for stabilizing current and filtering.

Sixth, for the two coils, at least one of them has its terminal sections to a PCB board offset, as shown in FIGS. 1 and 10. Electrodes are provided in the covering layer 3, which are respectively connected to the terminal sections of the first coil 1 and the second coil 2, and are welded to the PCB board via the electrodes.

Seventh, there is a gap D between the two coils, or there is at least one isolation layer 4 (non-conductive material) between the two coils to isolate them and avoid short circuits.

In general, when the first coil 1 and the second coil 2 overlap in arrangement, the space and dimension often lead to relatively lower inductance. The present invention addresses this by forming the third terminal section 22 and the fourth terminal section 23 in a staggered arrangement, utilizing the first body section 11 of the first coil 1, composed of multiple straight segments 111 and curved segments 112, and the second body section 21 of the second coil 2, composed of an inclined segment 211, multiple straight segments 212, and curved segments 213. This arrangement increases the overlapping area of the third terminal section 22 and the fourth terminal section 23, thereby enhancing the inductance. Additionally, it's worth mentioning that the structure of the first coil 1 and the second coil 2 in the filling of alloy powder to form the covering layer 3 enhances the overall structural strength due to the increased overlapping area of the terminals caused by the staggered arrangement of the third terminal section 22 and the fourth terminal section 23.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. An inductor, comprising:
a first coil comprising a first body section, a first terminal section, and a second terminal section, where the first body section comprises a plurality of straight segments and curved segments alternately end-to-end connected together, the first terminal section and the second terminal section are connected to the first body section's two ends, respectively, the first terminal section is straight, the second terminal section is bent, and both the first terminal section and the second terminal section are arranged along a first straight line;
a second coil comprising a second body section, a third terminal section, and a fourth terminal section, where the second body section comprises an inclined segment, a plurality of straight segments and curved segments, the inclined segment is connected to alternately end-to-end connected straight and curved segments, the third terminal section and the fourth terminal section are connected to the second body section's two ends, the third terminal section is straight, the fourth terminal section is bent, the third terminal section and the fourth terminal section are arranged in a staggered manner, with the third terminal section and the fourth terminal section located on a second straight line and a third straight line, respectively; and
a covering layer made of alloy powder covering the first coil and the second coil.

2. The inductor according to claim 1, wherein at least an isolation layer is provided between the first coil and the second coil.

3. The inductor according to claim 1, wherein a gap is provided between the first coil and the second coil.

4. The inductor according to claim 1, wherein he first coil and the second coil are placed on a core; and the core is positioned on a core base.

5. The inductor according to claim 1, wherein the alloy powder is FeSiCr alloy powder.

6. The inductor according to claim 1, wherein the first coil and the second coil are flat coils.
